(19) United States
(12) Patent Application Publication
(10) Pub. No.: US 2011/0079654 A1
(43) Pub. Date: Apr. 7, 2011

(54) Irrigation evacuation system

(76) Inventors: Jeffery Lynn Bailey, Bend, OR (US); Daniel Anthony De Grossa, Bend, OR (US)

(21) Appl. No.: 12/924,670

(22) Filed: Sep. 30, 2010

Related U.S. Application Data
(60) Provisional application No. 61/278,301, filed on Oct. 6, 2009.

(51) Int. Cl. B05B 15/00

(52) U.S. Cl. 239/1; 239/104; 239/75

(57) ABSTRACT

An improved irrigation evacuation system and method, to use in conjunction with an existing automatic irrigation system for controlling the sequence and duration of purging water from each irrigation zone. The system comprises an air source of adequate volume and pressure having an air outlet, a purge controller, a plurality of existing solenoid valves having corresponding irrigation zones, the air source being of adequate volume and pressure to evacuate the water from at least one irrigation zone, the air outlet being in fluid communication with the existing solenoid valves, the purge controller being in signal communication with the existing solenoid valves whereby upon purge initiation, the purge controller opens one existing solenoid valve thereby putting the corresponding irrigation zone in flow communication with the air source until purged, the purge controller then closing the solenoid valve, sequencing to the next solenoid valve, and repeating until all irrigation zones are purged. Embodiments include a temperature sensor in signal communication with the purge controller thereby allowing for purge initiation upon the temperature reaching a set point. Further embodiments include a pressure sensor in signal communication with the purge controller thereby providing for the purge controller to sense when purging of an irrigation zone is complete allowing for the sequencing to the next irrigation zone. The purge time for each irrigation zone may be set by the user, come preset as programmed within the purge controller, or be set during the first purge.

### CROSS REFERENCE TO RELATED APPLICATION

The present application claims the benefit of US provisional Application No. 61/278,301 filed on Oct. 2, 2009, which is incorporated herein by reference.

### TECHNICAL FIELD OF THE INVENTION

The present invention relates in general to water purging irrigation systems suitable for use in colder climates where freezing of the irrigation system occurs. More specifically, the present invention relates to an improved irrigation evacuation system and method, to use in conjunction with an existing automatic irrigation system, for controlling the sequence and duration of purging water from each irrigation zone with a controlled air source of adequate pressure and temperature.

### DESCRIPTION OF THE RELATED ART

Automatic irrigation systems require winterization in order to prevent freezing and damage to critical components of the system. Typically, irrigation systems are comprised of underground water supply lines with a set of sprinkler heads and/or emitters that allow the water to drain out in order to prevent freeze damage to the water supply lines. Compressed air is used to force the water out to purge through the sprinkler heads and/or emitters.

Most of the automatic irrigation systems are managed by an irrigation controller used with lawn sprinklers and drip irrigation systems. The controllers provide the means of setting the frequency of irrigation, the start time, and the duration of watering the irrigation zone. Some controllers have additional features such as multiple programs to allow different watering frequencies for different types of plants within the different irrigation zones.

Automatic irrigation systems employ electromechanical or electronic irrigation controllers that are connected to an electrical circuit that operates a solenoid attached to each valve. When the solenoid is actuated, the water above the diaphragm is relieved and the valve opens to provide water to a particular irrigation zone within the irrigation grid. Each irrigation zone or irrigation grid is of a size not to exceed the water volume and pressure capacities of the water source. In the case when two zones are operated at the same time, the water source should have a size and capacity matching the water requirements of all the irrigation zones activated at the same time.

Various automatic irrigation systems that accomplish the purging of water in utilizing different types of equipment have been devised in the prior art to prevent water from freezing in the pipes. This purging is accomplished generally by a sustained burst of air of sufficient quantity (CFM) and pressure (PSI) to activate the sprinkler heads thus forcing out the water and clearing the water supply lines. The different aspects of a purging system includes the source for the air such as tank, compressor or blower, a flow of air to and through the irrigation system which can be achieved through manifold, pipes or valves, the signature characteristics of the air burst (ramp up CFM as a function of PSI), and overall system control.

Conventional purging systems are labor intensive requiring an irrigation technician or home owner to purge the system. In commercial applications, the contractors will engage large volume and costly purging compressors that require their own trailer or a dedicated truck platform to move. This type of system and method often leads to additional contractor work and expense repairing damaged lines and dislocated sprinkler heads as the large air source is engaged to the entire irrigation system at once, purging the entire system.

U.S. Pat. No. 5,857,480 issued to Klein on Jan. 12, 1999 discloses a water purging system that includes a primary water line having a first end with threads for the receipt of a faucet constituting a source of water and a second end with threads for coupling to a supplemental water line adapted to be purged of water after usage. An air tank is provided for the receipt of compressed air and for expelling the compressed air into the primary line and supplemental line. The secondary line has a first end coupled with the air tank and a second end coupled to a central extent of the primary line. The secondary line also has a one-way check valve for the flow of air from the air tank to the primary and supplemental lines. The system further includes a turbine having a first end operatively coupled to the air tank and having a second end operatively coupled to the primary line. The turbine includes a housing having a cylindrical bore with an air piston reciprocally mounted therein. The turbine contains water turbine vanes in the primary line adapted for rotation upon the flow of water and the air piston to reciprocate the air piston upon rotation of the vanes to generate pressurized air for into the air tank. Such a system does not provide any solenoid valves for optimizing the purging of water by minimizing the volume of air necessary to purge water adequately. In addition, this system lacks a pressure sensor to determine when purging is complete, or a temperature sensor to initiate purging upon reaching a preset temperature.

U.S. Pat. No. 7,377,286 issued to King on May 27, 2008 discloses a drain valve having a temperature responsive member that holds the drain valve in a water conserving mode when water is above freezing yet allows the drain valve to drain when the water is near freezing to prevent freeze damage to the irrigation system. Such a system does not include an air source to maintain adequate pressure and volume in order to completely purge an irrigation system.

Hence, it can be seen that there is a need for an improved irrigation evacuation system and method to use in conjunction with an existing automatic irrigation system for controlling the sequence and duration of purging water from each irrigation zone with a controlled air source of adequate pressure and temperature. Such a system would be simple, economical to manufacture and install while designed to have an anti freeze setting. Moreover, such a system would purge water from the irrigation zones without large air compressors and without causing damage to the system due to high pressure conditions. In addition, the system would provide high purging effectiveness using a limited air source along with an automatic application that allows the system to easily integrate with an existing automatic irrigation system.

### SUMMARY OF THE INVENTION

To minimize the limitations found in the prior art, and to minimize other limitations that will be apparent upon the reading of the specifications, the present invention provides an improved irrigation evacuation system and method to use in conjunction with an existing automatic irrigation system. The system comprises an air source, a purge controller and a plurality of signal connectors. The air source includes a purging motor, a purging pump, an air inlet and an air outlet. The air outlet is in fluid communication with an existing water inlet thereby providing adequate air volume and air pressure to purge a plurality of existing irrigation zones. The purge controller is in signal communication with the air source and the plurality of signal connectors provides a signal communication between the purge controller and a plurality of existing solenoid valves. When the purge controller initiates water evacuation, the water inlet is closed off and the air source comes into full air communication with the system. By purging one irrigation zone at a time, the amount of air necessary to purge is decreased.

In another aspect of the present invention, the system may include an air reservoir that is in flow communication between the air source at the air outlet, and the existing solenoid valves. The purge controller includes a programmable logic controller having an internal timer system that can be easily programmed using an external input signal. The timer allows a user to set purging time for the sequential opening of the plurality of solenoid valves. The air reservoir embodiment stores adequate pressure required for purging of the plurality of valve solenoids sequentially according to the preset purging time.

One objective of the invention is to provide an improved irrigation evacuation system and method, to use in conjunction with an existing automatic irrigation system, for controlling the sequence and duration of purging water from each irrigation zone with a controlled air source of adequate pressure.

Another objective of the invention is to provide an improved irrigation evacuation system in which the water source is closed off from the irrigation system when the purging system is activated and the air source comes into full air communication with the irrigation system thereby purging one station or irrigation zone at a time as per the purging controller signal, thereby decreasing the amount of air necessary to purge the entire system as it is purged sequentially, i.e., irrigation zone by irrigation zone, using already installed hardware, managed by the purging controller.

A third objective of the invention is to provide an improved irrigation evacuation system with the purge controller that will be adaptable to be programmable by the user during the first purge, or preset for a particular irrigation zone size thereby comparative purging demands of the particular irrigation zone is regulated to the known capacity of the air source, equating to a purging controller protocol that sets the frequency and duration of the valve opening and closing in order to facilitate a full purge.

Still another objective of the invention is to provide an improved irrigation evacuation system with the purging controller that may manage the air source by controlling the motor speed that powers the air pump by a signal from the purge controller.

Yet another objective of the invention is to provide an improved irrigation evacuation system that includes a temperature sensor in signal communication with the purge controller and when the temperature reaches a preset value, the purge controller shuts off the water inlet initiates the air source and then sequentially purges the water from each of the plurality of existing irrigation zones.

A further objective of the invention is to provide an improved irrigation evacuation system that includes a pressure sensor in signal communication with the purge controller and in air communication with the air outlet, when the pressure reaches a constant level, the purge controller shuts off one of the plurality of existing irrigation zones, allows back pressure to build, and then sequentially opens another irrigation zone to be purged.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a diagrammatic representation of an improved irrigation evacuation system and method to use in conjunction with an existing automatic irrigation system;

FIG. 2 is an electrical schematic diagram illustrating one presently preferred configuration of the signal connections for a purge controller constructed of a programmable logic controller;

FIG. 3a is a perspective view of an air source in accordance with the present invention;

FIG. 3b is a top perspective view of an air source, illustrating a purging motor, a purging pump, an air inlet and an air outlet;

FIG. 3c is a side perspective view of an air source, illustrating a purging motor, a purging pump and an air inlet;

FIG. 3d is a diagrammatic representation illustrating the controlled air source for regulating the air volume and pressure as required to purge out the water from the system; and

FIG. 4 schematically shows a perspective view of a field employing the improved irrigation evacuation system and method to use in conjunction with an existing automatic irrigation system.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

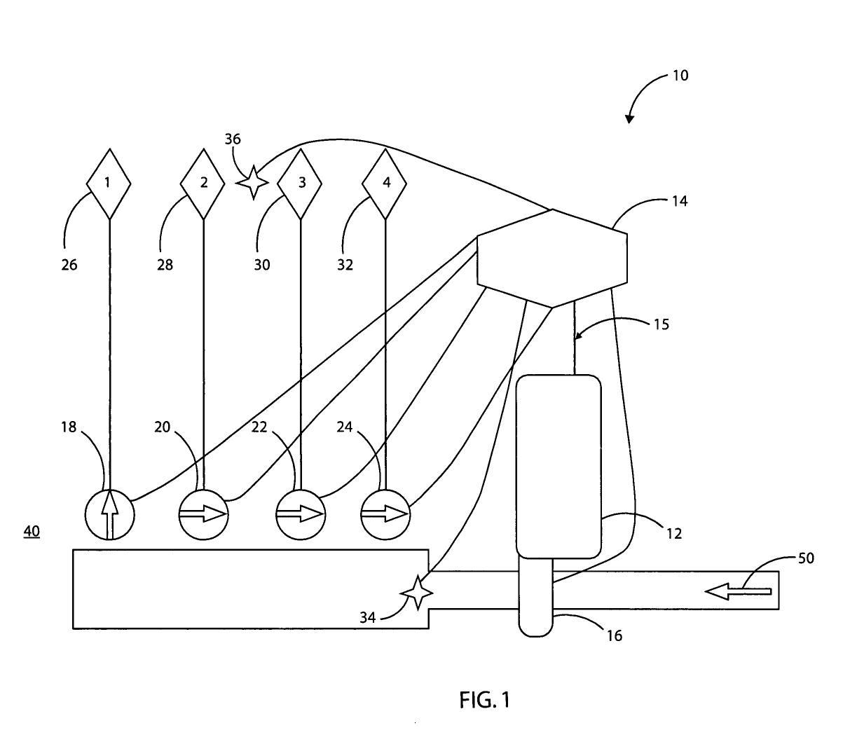

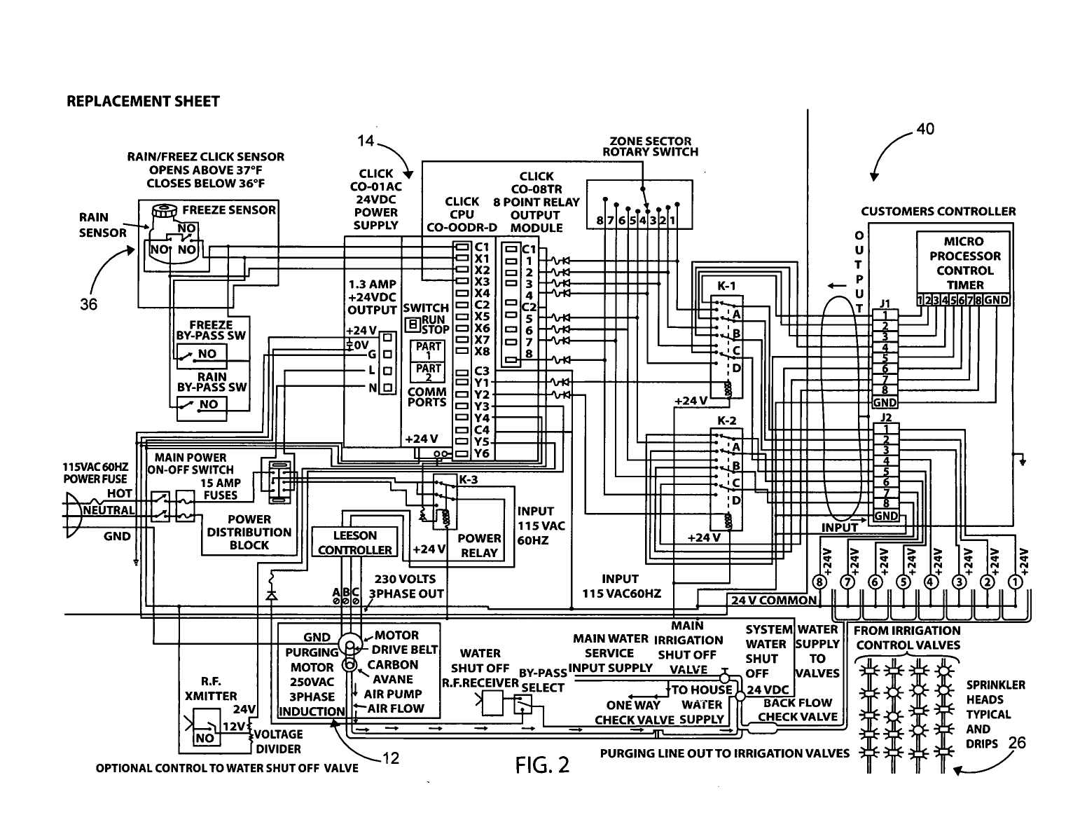

FIG. 1 is diagrammatic representation of a preferred embodiment of an improved irrigation evacuation system 10 and method to use in conjunction with an existing automatic irrigation system 40. The system 10 comprises an air source 12, a purge controller 14 and a plurality of signal connectors (shown in FIG. 2). The air source 12 includes a purging motor (shown in FIG. 2), a purging pump (shown in FIG. 2), an air inlet (shown in FIG. 2) and an air outlet (shown in FIG. 2). The air outlet (shown in FIG. 2) is in fluid communication with an existing water inlet 50 thereby providing adequate air volume and air pressure to purge at least one existing irrigation zones 26, 28, 30 and 32. The purge controller 14 is in controller communication 15 with the air source 12 and the plurality of signal connectors (shown in FIG. 2) are in electrical signal communication between the purge controller 14 and a plurality of existing solenoid valves 18, 20, 22 and 24.

In the simplest embodiment the air source 12 is simply turned on and put into flow communication with the automatic irrigation system 40. Upon purging initiation by the user, or upon a signal from a pressure sensor 34 or temperature sensor 36, the purge controller 14 sequentially opens one existing solenoid valve at a time, closing the same after the corresponding irrigation zone has the water evacuated via the air source 12 that is in flow communication with the automatic irrigation system 40.

In another embodiment, the purge controller 14 may initiate the air source 12 via controller communication 15 to turn on the air source 12 to build up adequate pressure prior to initiation of purging the first irrigation zone by opening the first solenoid valve.

The purge controller 14 provides a sequential opening of each of the plurality of existing valve solenoids 18, 20, 22 and 24. When the solenoid valve 18 is open as shown in FIG. 1, the air source 12 is in flow communication with the irrigation zone 26 thereby providing adequate air to evacuate the irrigation zone 26. The purge controller 14 may sequence the plurality of solenoid valves 18, 20, 22 and 24 to the open position for a set period of time as necessarily required to adequately purge the corresponding plurality of existing irrigation zones 26, 28, 30 and 32. The existing valve solenoids 18, 20, 22 and 24 provides a flow communication between the water inlet 50 and the system 10, allowing the water inlet 50 shut off before sequentially opening each of the plurality of valve solenoids 18, 20, 22 and 24 until purging of the water is completed. When the purging system is activated, the water inlet 50 is closed off from the existing irrigation system 40, and the air source 12 comes into full air communication with the existing irrigation system 40. By purging one of the plurality of existing irrigation zones 26, 28, 30 and 32 at a time, the amount of air necessary to purge is decreased, and the existing irrigation system 40 is purged sequentially, irrigation zone by irrigation zone, using already installed hardware, managed by the purging controller 14.

The system 10 may further comprise an air reservoir 16 that is in flow communication with the air source 12. The air reservoir 16 stores adequate air volume at the pressure provided by the air source 12, required for purging through the plurality of valve solenoids 18, 20, 22 and 24 sequentially according to the preset purging time. The air reservoir 16 may be of similar construction and design as that of a pressure tank commonly found on residential well systems. The air reservoir 16 could be a fixed volume like a pressure tank, or an expanding volume with pressure like a balloon or elastic bladder, depending on the total volume of air required to adequately purge the particular irrigation zone. The benefit of having an air reservoir 16 is a decrease demand on the air source 12 as the volume of air made available for purging can be augmented with the air reservoir 16.

The purge controller 14 includes a programmable logic controller having an internal timer system that can be easily programmed using an external input signal. The timer allows a user to set purging time for the sequential opening of the plurality of solenoid valves 18, 20, 22 and 24. For example, the user installs the improved irrigation evacuation system 10 and during a first purge, the first valve 18 is opened and the corresponding irrigation zone 26 is evacuated of water. When complete, the user signals the purge controller 14 by detent button or other input means that the corresponding irrigation zone 26 until it is purged. By program or algorithm encoded in the programmable logic controller of the purge controller 14, the solenoid valve 18 is closed, and the purge controller 14 then initiates to opens valve 20 putting irrigation zone 28 in flow communication with the air source 12. The purge controller 14, follows the same process and repeats until the plurality of existing irrigation zones 26, 28, 30 and 32 are purged. The purge controller 14 stores into memory the time period set by the user as being necessary to purge each of the plurality of existing irrigation zones 26, 28, and 32. The next time the purge controller 14 initiates purging, it repeats user set time periods to leave open the valves 18, 20, 22 and 24 thereby efficiently purging the corresponding plurality of existing irrigation zones 26, 28, 30 and 32 within the shortest period of time based on the available air source 12.

As discussed, rather than attempting to purge the entire irrigation system 40 at once, the purge controller 14 opens one of the plurality of solenoid valves 18, 20, 22 and 24 at a time, thereby purging one of the plurality of existing irrigation zones 26, 28, 30 and 32 at a time, thereby providing a successful purge with only a fraction of the air volume and pressure necessary to purge the existing irrigation system 40 at once.

This purging controller 14 may be of the same type as an automatic irrigation controller, but having a unique controller program specific to the purging task. The purge controller 14 program balances the plurality of existing irrigation zones 26, 28, 30 and 32 purging requirement with the purging air source 12 potential as augmented in the preferred embodiment with an air reservoir 16. The comparative purging demands of the particular irrigation zone is regulated to the known capacity of the air source 12 as augmented with an air reservoir 16 equating to a purging controller 14 protocol that sets the frequency and duration of the opening of the plurality of valves 18, 20, 22 and 24 and closing in order to facilitate purge. Larger irrigation zones will require a longer purging blast in order to facilitate complete purging. The purge controller 14 will be adaptable to be programmable by the user during the first purge, or preset for a particular irrigation zone size.

The system 10 comprises a pressure sensor 34 in signal connection with the purge controller 14 and in air communication with the air outlet 76 or if more convenient, in air communication with the air reservoir 16. The pressure sensor 34 senses the differential pressure when the plurality of solenoid valves 18, 20, 22 and 24 opens and closes thereby determines when the purging of water is completed. For example, when the solenoid valve 18 is opened, the air pressure at the pressure sensor 34 will drop suddenly as air flows through the solenoid valve 18 and out to evacuate water through the irrigation zone 26. As the water is evacuated, the pressure at the pressure sensor 34 will gradually reach a constant pressure indicating that the irrigation zone 26 has been purged and the air is leaking out of the sprinkler heads or emitters without the additional resistance of pushing out water. When the pressure at the pressure sensor 34 is constant for a predetermined time, the purge controller 14 shuts off the solenoid valve 18 and may sequences to the next solenoid valve 20, repeating for each of the plurality of existing irrigation zones 26, 28, 30 and 32. The purge controller 14 may also shut off all of the solenoid valves allowing the air source 12 to build adequate pressure as indicated by the pressure sensor 34 before opening the next solenoid valve and purging the next irrigation zone.

The system 10 further comprises a temperature sensor 36 in signal connection with the purging controller 14. The purging controller 14 may be set with a predetermined/preset temperature as sensed by the temperature sensor 36. The temperature sensor 36 initiates purging sequence of the water from each of the plurality of solenoid valves 18, 20, 22 and 24 upon a preset temperature. Upon reaching the preset temperature, the purging controller 14 initiates evacuation, sends signal to air reservoir 16 to shut off the water supply through water inlet 50 and bring the air source 12 in flow communication with the plurality of solenoid valves 18, 20, 22 and 24, and then purging the irrigation zones as described herein, one at a time.

FIG. 2 is an electrical schematic diagram illustrating one presently preferred configuration of the signal connections for a purge controller 14 having a programmable logic controller. In the preferred embodiment, the pressure sensor 34 in signal connection with the purge controller 14 senses the pressure in the air reservoir 16. Before the purge controller 14 opens, for example, the solenoid valve 18, the air pressure in the reservoir 16 must be at adequate levels so as to purge the irrigation zone 26 associated with solenoid valve 18. If the pressure in the air reservoir 16 is inadequate, the solenoid valve 18 is kept closed while the purging pump shown as the air source 12 builds adequate pressure. Once the purge controller 14 receives the signal that the pressure at the air reservoir 16 is adequate as shown and described in FIG. 1, the solenoid valve 18 is opened and the corresponding irrigation zone 26 is purged. By waiting for the air reservoir 16 to build up pressure, thereby containing additional air volume at pressure, the air source 12 is not required to output as much air volume, thereby decreasing costs of the system, by saving the expense of a larger air source 12.

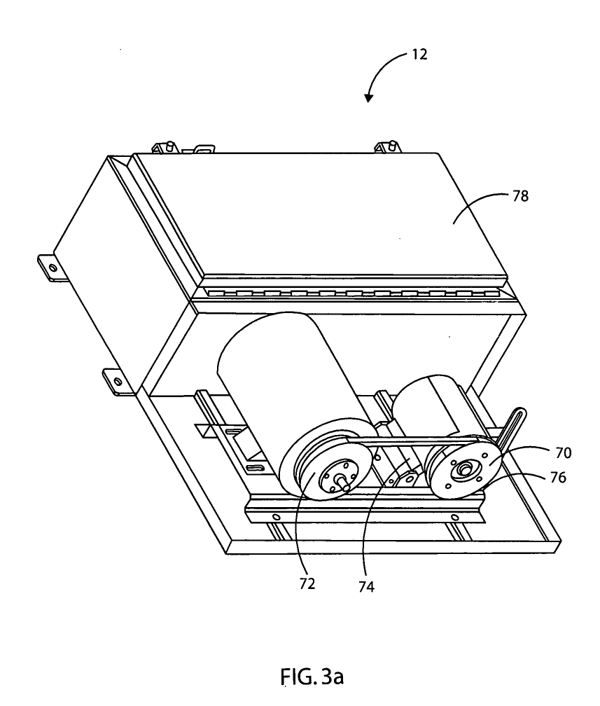

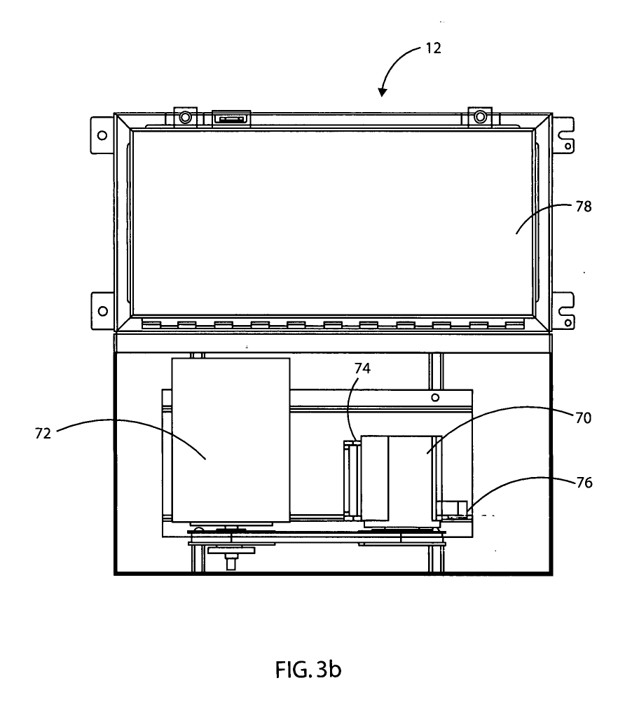

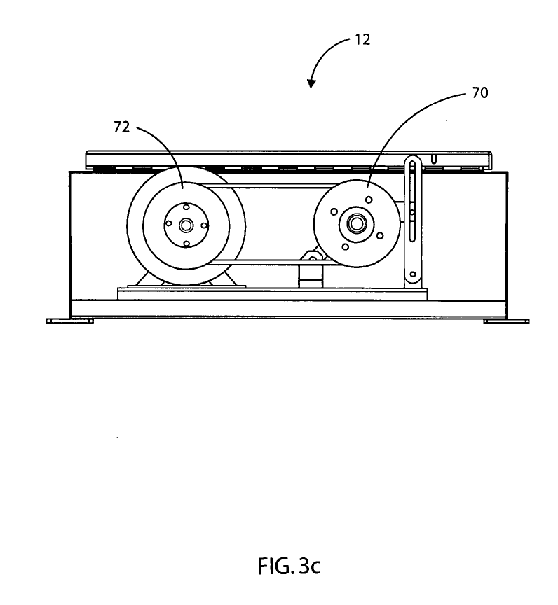

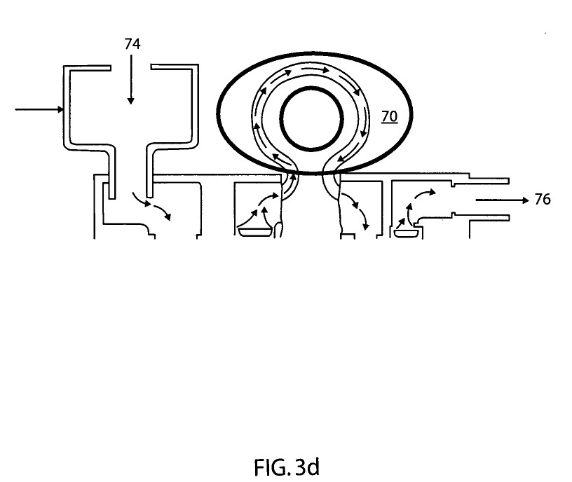

FIGS. 3a, 3b, 3c and 3d illustrate a perspective view of the air source 12 having a purging pump 70, a purging motor 72, an air inlet 74 and an air outlet 76 therein. The controlled air source system 12 provided with the improved irrigation evacuation system 10 is stored in a box. The purge controller 14 may manage the air source 12 by controlling the purging motor 72 speed that powers the purging pump 70 by a signal from the purge controller 14. The purging pump 70, purging motor 72, air inlet 74, and air outlet 76 are enclosed in the box with a containment lid 78. The air source 12 may be constructed from an electric motor driving a carbon vane air pump, the type of pump one would find on an automobile motor performing the smog pump task.

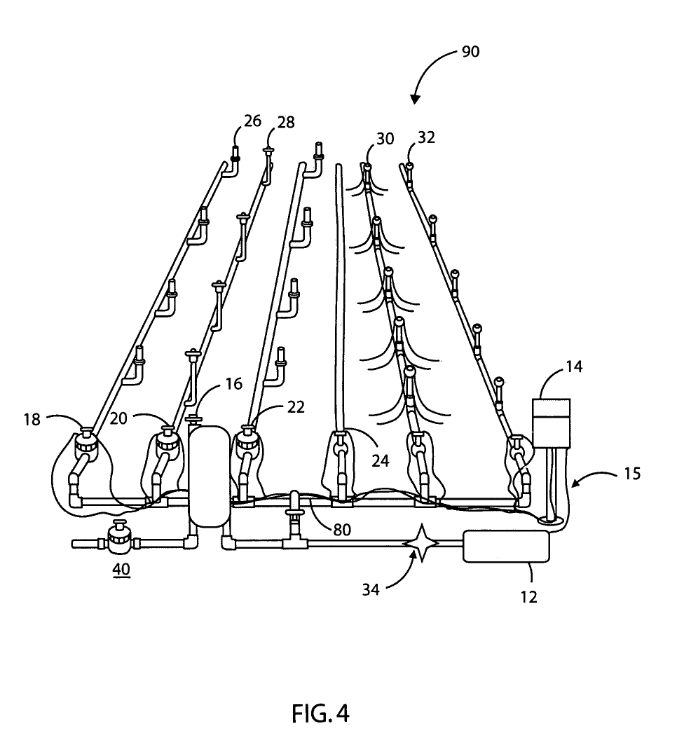

FIG. 4 schematically shows a perspective view of a field 90 having installed an automatic irrigation system 40, having a plurality of irrigation zones 26, 28, 30, and 32. Each irrigation zone has a corresponding solenoid valve, solenoid valve 18 corresponds to irrigation zone 26 solenoid valve 20 to irrigation zone 28 and so on. The purge controller 14 connects to each solenoid via common conductor wire 80 that is of adequate composition and gauge to handle 24 volts, the common control voltage for the solenoid valves used in most automatic irrigation systems.

The purge controller 14 initiates the air source 12 via controller communication 15. Controller communication 15 may be a wire, a radio frequency relay, or some other communication means wherein the purge controller 14 can turn on, turn up, and turn off the air source 12. Once initiated, the air source 12 in flow communication with the air reservoir 16 and solenoid valves 18, 20, 22, and 24 builds pressure. As shown, the air reservoir 16 is in flow communication with the air source 12, and could be located either closer or farther away from the air source 12, so long as it is in air communication.

Through experimentation and testing, most residential systems require 12 psi of purging pressure in order to evacuate a single irrigation zone, but pressures up to residential water pressure levels of 70 psi make the purging process quicker. The pressure of 24 psi is preferred, as 24 psi is easily obtained in most economic air sources 12 and does not under normal circumstances cause any damage.

Once the desired pressure is reached at the air reservoir 16, the purge controller 14 signals solenoid valve 18 to open thereby releasing the air into the irrigation zone 26. Once the purge controller 14 senses via pressure sensor 34 that the water is evacuated, or in the alternative, the purge controller 14 times out, the purge controller 14 shuts off solenoid valve 18. The air source 12 continues to build pressure in the air reservoir 16 until the purge controller 14 senses via pressure sensor 34 that adequate pressure is present to purge, then initiates solenoid valve 20 to purge irrigation zone 28 and so on.

The purge controller 14 may also perform the same function as described herein, but without a pressure sensor 34. The purge controller 14 would sequence as described herein on a timer with each irrigation zone given a certain time period to purge, without the benefit of managing the water evacuation by present pressure.

The system 10 may perform the water evacuation tasks described herein without the air reservoir 16. The air reservoir 16 augments the system, but is not necessary as the existing water lines of the automatic irrigation system 40 have adequate volume to work with some air sources 12. The necessary outputs of the air source 12 may increase if there is no air reservoir 16 to assist with the purging.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An improved irrigation evacuation system for use in conjunction with an existing automatic irrigation system comprising:
an air source having an air outlet;
a purge controller;
a plurality of solenoid valves corresponding to a plurality of irrigation zones;
the air source being of adequate volume and pressure to evacuate the water from at least one irrigation zone,
the air outlet being in fluid communication with the solenoid valves;
the purge controller being in signal communication with the existing solenoid valves whereby upon purge initiation, the purge controller opens one existing solenoid valve at a time, putting the corresponding irrigation zone in flow communication with the air source until purged, the purge controller then closing the solenoid valve, sequencing to the next solenoid valve, and repeating until all irrigation zones are purged.

2. The improved irrigation evacuation system of claim 1 wherein the purge controller is constructed of a programmable logic controller having an internal timer system that allows a user to set purging time for the sequential opening of each of the solenoid valves.

3. The improved irrigation evacuation system of claim 1 wherein the system further comprises:
a temperature sensor;
the purge controller being in signal communication with the temperature sensor whereby the purge controller initiates purging sequence automatically when the temperature sensor signals a preset temperature.

4. The improved irrigation evacuation system of claim 1 wherein the system further comprises a pressure sensor in air communication with the air outlet, and in signal communication with the purge controller whereby the purge controller opens one existing solenoid valve and closes the same upon the pressure sensor sensing constant pressure relating to water purged from the corresponding irrigation zone, repeating for each solenoid valve.

5. The improved irrigation evacuation system of claim 1 wherein the system further comprises a pressure sensor in air communication with the air outlet, and in signal communication with the purge controller whereby the purge controller opens each solenoid when the pressure sensor senses desired purging pressure.

6. The improved irrigation evacuation system of claim 1 wherein the purge controller is in signal communication with the air source providing on and off control

7. The improved irrigation evacuation system of claim 1 wherein the system further comprises an air reservoir that is in flow communication with the air source outlet.

8. The improved irrigation evacuation system of claim 1 wherein the system further comprises an air reservoir that is in flow communication with the valve solenoids.

9. The improved irrigation evacuation system of claim 1 wherein the system further comprises a pressure sensor in air communication with an air reservoir and the pressure sensor being in signal communication with the purge controller whereby the purge controller does not initiate purging until the air reservoir reaches desired pressure.

10. The improved irrigation evacuation system of claim 9 wherein the desired pressure is more than 12 pounds per square inch and less than 24 pounds per square inch.

11. A method for an improved irrigation evacuation system for purging that utilizes an existing automatic irrigation system comprising the steps of:
a) installing the improved irrigation evacuation system in conjunction with the existing automatic irrigation system;
b) setting up time periods to leave open each of a plurality of existing solenoid valves by using an internal timer system in a purge controller;
c) signaling the purge controller by clicking the detent button/input means to open a first solenoid valve and to initiate timing of first purge;
d) the first open existing solenoid valve putting the first corresponding existing irrigation zones in flow communication with an air source for the set time period;
e) the purge controller repeats purging time period for each valve solenoid until all of the existing irrigation zones are purged;

12. The improved irrigation evacuation system method of claim 11 wherein the steps further include the installation of an air reservoir in flow communication with the solenoid valves.

13. An improved irrigation evacuation system comprising:
an air source having an air outlet;
a purge controller;
a pressure display;
a pressure sensor;
a plurality of valves corresponding to a plurality of irrigation zones;
the pressure sensor in flow communication with the valves, and signal communication with the pressure display;
the air source being of adequate volume and pressure to evacuate the water from at least one irrigation zone,
the air outlet being in fluid communication with the valves;
the user opens one valve at a time, putting the corresponding irrigation zone in flow communication with the air source until the pressure display indicates stable pressure, then sequencing to the next valve, and repeating until all irrigation zones are purged.
